(19) United States
(12) Patent Application Publication
(10) Pub. No.: US 2024/0106011 A1
(43) Pub. Date: Mar. 28, 2024

(54) PROCESS AND CHEMICALS FOR IN-SITU PRE-LITHIATION OF LITHIUM-ION BATTERY ANODES

(71) Applicant: Apple Inc., Cupertino, CA (US)

(72) Inventors: Jian Hong, Cupertino, CA (US); Shabab Amiruddin, Pacifica, CA (US); Karthikeyan Kumaresan, Sunnyvale, CA (US)

(73) Assignee: Apple Inc., Cupertino, CA (US)

(21) Appl. No.: 18/367,987

(22) Filed: Sep. 13, 2023

Related U.S. Application Data
(60) Provisional application No. 63/409,128, filed on Sep. 22, 2022.

(51) Int. Cl. H01M 10/42; H01M 4/134; H01M 4/38; H01M 10/04; H01M 50/609

(52) U.S. Cl. CPC H01M 10/4235; H01M 4/134; H01M 4/382; H01M 10/0431; H01M 50/609

(57) ABSTRACT

Described are pre-lithiated anode active materials, lithium-ion electrochemical cells comprising pre-lithiated anode active materials, methods for preparing pre-lithiated anode active materials, and lithium-ion electrochemical cells comprising pre-lithiated anode active materials. The disclosed processes are useful for adapting various methods for manufacturing for lithium-ion electrochemical cells with modifications to achieve pre-lithiation. The pre-lithiation process used by some embodiments described herein include treating an incomplete lithium-ion cell structure with a lithiation redox agent prior to injecting electrolyte into the cell, using techniques similar to the electrolyte injection process.

### CROSS-REFERENCE TO RELATED APPLICATIONS

This application claims the benefit of and priority to U.S. Provisional Application No. 63/409,128, filed on Sep. 22, 2022, entitled “PROCESS AND CHEMICALS FOR IN-SITU PRE-LITHIATION OF LITHIUM-ION BATTERY ANODES,” the content of which is herein incorporated by reference.

### TECHNICAL FIELD

The present technology relates to electrode active materials for lithium-ion battery cells. More specifically, the present technology relates to pre-lithiated anode active materials and methods for preparing anode active materials for lithium-ion battery cells.

### BACKGROUND

Conventional lithium-ion battery cells typically include a lithium metal oxide cathode active material, a graphite anode active material, and an electrolyte comprising a lithium salt dissolved in an organic solvent. On assembly, such cells are typically prepared in a discharged state, where no lithium is present on the anode side, and so the cells need to undergo a first charge cycle before they can be used. During charging, some amount of lithium may be consumed by side reactions and formation of a solid electrolyte interphase (SEI) on the surface of the graphite anode, resulting in an amount of lithium being lost for participation in active electrochemical reactions. In other anode systems, such as silicon-based anodes, the amount of lithium that is lost can be even greater, due to the volumetric expansion of silicon upon lithiation, which can result in amounts of the anode material becoming electrically isolated from the rest of the anode and, therefore, lost for participation in active electrochemical reactions. Techniques for dealing with loss of lithium in lithium-battery systems are needed.

### BRIEF DESCRIPTION OF THE DRAWINGS

A further understanding of the nature and advantages of the disclosed embodiments may be realized by reference to the remaining portions of the specification and the drawings.

FIG. 1 provides a schematic illustration of an example lithium-ion electrochemical cell, in accordance with some examples.

FIG. 2 shows a schematic illustration of an example lithium-ion electrochemical cell comprising a jelly roll, in accordance with some examples.

FIG. 3 provides an overview of an example method of preparing electrochemical cells with excess lithium in the anode active material and/or with or pre-lithiated anode active material, in accordance with some examples.

FIG. 4 depicts lithiation redox agents for driving both lithiation of anode active material as well as formation of a solid-electrolyte interphase layer.

Several of the figures are included as schematics. It is to be understood that the figures are for illustrative purposes and are not to be considered to scale unless specifically stated to be to scale. Additionally, as schematics, the figures are provided to aid comprehension and may not include all aspects or information compared to realistic representations, and may include exaggerated material for illustrative purposes.

In the figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION

Described herein are pre-lithiated anode active materials, lithium-ion electrochemical cells comprising pre-lithiated anode active materials, and methods for preparing pre-lithiated anode active materials and lithium-ion electrochemical cells comprising pre-lithiated anode active materials. The use of pre-lithiated anode active materials provides for the ability to retain high capacity in lithium-ion electrochemical cells for high cycle numbers since the pre-lithiation process can provide excess lithium to the anode, which can be accessible to a cell as lithium is consumed by formation of solid-electrolyte interphase layers, other undesirable side reactions, or mechanical/electrical disconnections of electrode materials. The disclosed processes are useful for adapting various methods for manufacturing of lithium-ion electrochemical cells with modifications to achieve pre-lithiation. The pre-lithiation process used by some embodiments described herein include treating an incomplete lithium-ion cell structure with a lithation redox agent prior to injecting electrolyte into the cell, using techniques similar to the electrolyte injection process.

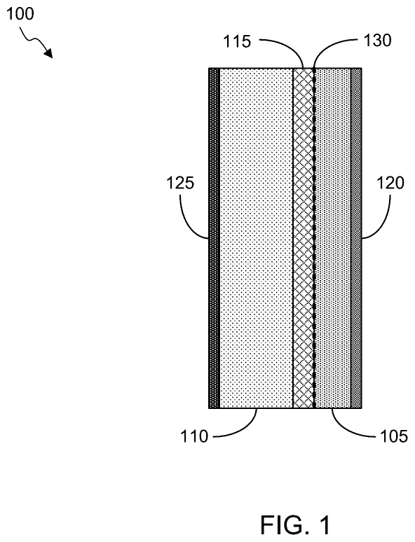

FIG. 1 provides a schematic illustration of an example lithium-ion electrochemical cell 100, comprising an anode active material 105 (e.g., not metallic lithium), a cathode active material 110, an electrolyte 115, an anode current collector 120, and a cathode current collector 125. In some lithium-ion battery systems, the cathode current collector 125 comprises aluminum foil, the cathode active material 110 comprises a lithium metal oxide, the anode active material 105 comprises graphite, the anode current collector 120 comprises copper foil, and a porous non-conductive material (separator) soaked with a liquid electrolyte 115 comprising an organic solvent and a lithium salt is positioned between the anode active material 105 and the cathode active material 110. Variations on these components are possible, such as where the cathode active material 110 comprises sulfur or a lithium transition-metal phosphate, and/or where the electrolyte 115 is a polymer electrolyte or a solid electrolyte, and/or where the anode active material 105 comprises silicon or tin. In examples, the cathode active material 110 may comprise or correspond to any desirable class of cathode active material, such as a fully delithiated cathode active material, a charged lithium-ion cathode active material, a fully lithiated cathode active material, or a discharged lithium-ion cathode active material.

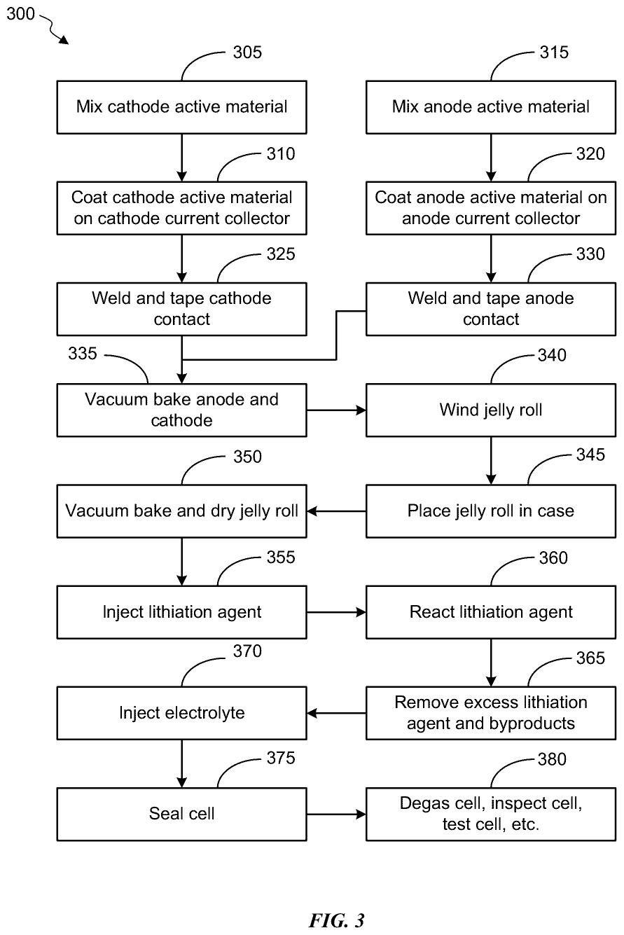

In a pre-lithiated electrochemical cell according to the present disclosure, anode active material 105 includes an excess amount of lithium. The excess amount of lithium may correspond to a quantity of lithium that is greater than needed to or greater than can be used to fully discharge the electrochemical cell. For example, the excess amount of lithium may correspond to a quantity of lithium that is greater than an amount of delithiation of the cathode active material 110 or a lithium capacity of the cathode active material 110. Optionally, the anode active material 105 in a pre-lithiated electrochemical cell may further include a solid-electrolyte interphase (SEI) layer 130 on the surface of the anode active material 105. SEI layer 130 is illustrated in FIG. 3 as a layer between electrolyte 115 and cathode active material 105, but it will be appreciated that the SEI layer 130 can be present on any surface of the individual particles or material making up anode active material 105, such as may be in contact with the electrolyte 115.

In some examples, the excess amount of lithium in the anode may correspond to a quantity of lithium greater than an amount of lithium in the SEI 130 and one or both of an amount of delithiation of the cathode active material 110 or a lithium capacity of the cathode active material 110. With excess lithium present in the anode active material 105, this lithium may be available for electrochemical reactions as lithium is irreversibly lost during operation of the electrochemical cell, such as lost to formation of the SEI 130. In some cases, introducing excess lithium into the anode active material may simultaneously generate the SEI 130, limiting use of lithium in the cathode active material 110 for generating the SEI 130.

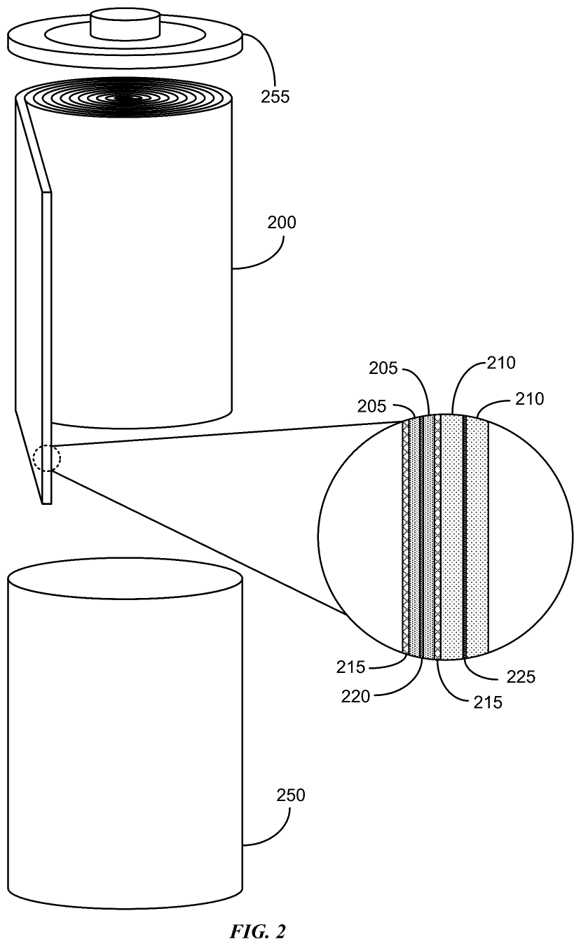

When lithium-ion electrochemical cells are constructed, the components may be assembled in a rolled, cylindrical form, referred to herein as a jelly roll. FIG. 2 shows a schematic illustration of an example jelly roll 200, which allows both sides of a cathode current collector 225 to be coated with a cathode active material 210 and, similarly, both sides of an anode current collector 220 to be coated with an anode active material 205, with a separator layer 215 between them. The wound construction of the jelly roll can provide an extended surface area for increased capacity and/or charging/discharging performance. The expanded inset in FIG. 2 shows a cross section of the jelly roll 200, showing anode active material 205, cathode active material 210, separator 215, anode current collector 220, and cathode current collector 225. A case 250 may house the jelly roll 200 in a completed electrochemical cell, which may serve to contain the jelly roll 200 and an electrolyte. Commonly, a case 250 may be made from aluminum and provide contact with the anode electrode current collector, for example. A cap 255 may seal the top of the case and provide contact with the cathode current collector, for example. In some examples, the anode and cathode connections may be switched. The cap 255 may be sealed to the case 250 to isolate the jelly roll 200 from the environment and provide a closed cell. Other cell types besides a cylindrical jelly roll are contemplated, such as prismatic cells, or pouch cells.

For pre-lithiation of electrochemical cells, such as those comprising a jelly roll (e.g., jelly roll 200), additional processing may be used beyond typical fabrication processes. FIG. 3 provides an overview of an example method 300 of preparing electrochemical cells with excess lithium in the anode active material and/or with or pre-lithiated anode active material. It will be appreciated that method 300 describes a variety of steps and more, fewer, or different processing steps may be used to prepare electrochemical cells with excess lithium in the anode active material and/or with or pre-lithiated anode active material. Further, the steps of method 300 may be performed in any suitable order and the order described here and shown in FIG. 3 is merely one example, and is not intended to be limiting.

In method 300, cathode and anode active materials are initially prepared and assembled on the respective current collectors. For example, the cathode active material is mixed at block 305, such as with suitable components (e.g., binder, solvent, conductive additives, etc.). At block 310, the cathode active material is coated on a cathode current collector. The anode active material is mixed at block 315, such as with suitable components (e.g., binder, solvent, conductive additives, etc.), for example. At block 320, the anode active material is coated on an anode current collector. At block 325 and 330 cathode and anode contacts may be welded (e.g., by spot welding or the like) and taped for protection.

At block 335, the anode and the cathode are vacuum baked, such as to cure the active materials. Once the anode and cathode are prepared, they may be wound, at block 340, with a separator into a jelly roll. Once the jelly roll is prepared, it may be placed into a case at block 345. When appropriate, electrical connections with one electrode and the case may be made. At block 350 the jelly roll and case may be placed into a vacuum oven, to as a final preparation process for the electrodes (e.g., to dry and finish any curing of the active material).

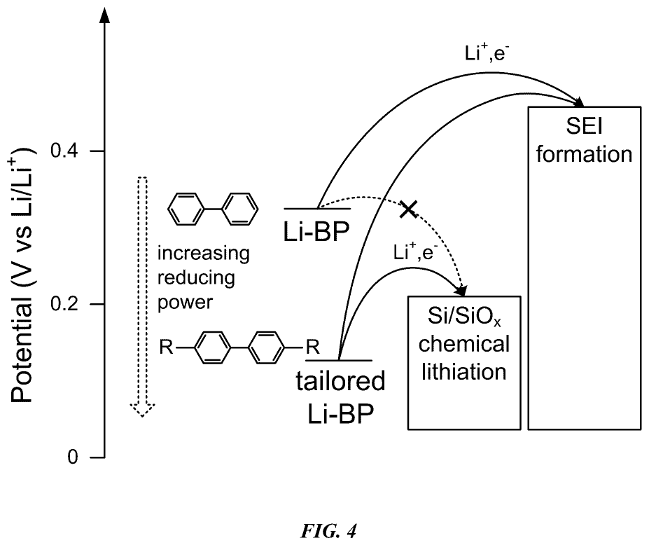

Following the vacuum bake, a lithiation agent may be injected into the case at block 355, such as into a space between the anode and the cathode, e.g., at the position of the separator. The lithiation agent may be a mixture of components, such as including lithium, an organic solvent, and an organic compound, such as naphthalene, a naphthalene derivative, biphenyl, or a biphenyl derivative. A variety of different lithiation redox agents may be used. In some examples, the lithiation redox agent comprises one or more organolithium compounds, such as dissolved or suspended in an organic solvent. For example, useful lithiation redox agents include, but are not limited to lithium naphthalene, a lithium naphthalene derivative, lithium biphenyl, a lithium biphenyl derivative. Useful organic solvents include, but are not limited to, tetrahydrofuran (THF), dimethoxyethane (DME), ethylene carbonate (EC), diethyl carbonate (DEC), dimethyl carbonate (DMC), ethyl methyl carbonate (EMC), propylene carbonate (PC), or ethyl proprionate (EP), or combinations of these. The specific identity and combination of lithiation redox agents or components may be tuned for a particular set of anode materials, such as to be useful for driving both lithiation of the anode active material, as well as formation of a SEI layer, as schematically depicted in FIG. 4. FIG. 4 shows that lithium biphenyl may be useful for driving formation of a SEI, but such material may not be electrochemically adequate for chemical lithiation (e.g., when the anode comprises Si/SiOx). In such case, additional lithiation redox agents, such as a tailored lithium biphenyl compound, including one or more non-hydrogen R group substituents, can be used to both drive driving formation of the SEI and also chemical lithiation of the anode.

Turning back to FIG. 3, at block 360, the lithiation redox agent may be allowed to react, such as to drive lithiation of the anode active material. In some examples, the lithiation redox agent may spontaneously react and begin lithiation of the anode active material. In other examples, an electrical potential may be applied to the anode or across the electrochemical cell to drive the lithiation of the anode active material. In some cases, reacting the lithiation redox agent with the anode active material comprises a chemical reaction without applying any potential. In some cases, reacting the lithiation redox agent with the anode active material comprises heating the lithiation redox agent with or without applying any potential. At block 365, the excess lithiation agent and any reaction products, as desired, may be removed from the jelly roll and case. For example, a vacuum degassing process may be applied to the jelly roll to remove excess lithiation agent.

Following the in-situ pre-lithiation achieved by blocks 355-365, an electrolyte can be injected into the case at block 370, such as into a space between the anode and the cathode, e.g., at the position of the separator. Following injection of the electrolyte, the cell may be sealed at block 375, followed by final processing of the cell at block 380. For example, upon or after the cell is sealed, the cell may be degassed, inspected, tested, checked for leaks, or the like.

The techniques described for preparing electrochemical cells with excess lithium in the anode active material and/or with or pre-lithiated anode active material can be advantageously adapted to a variety of lithium-ion battery cell preparation methods and systems. The processes of injecting a lithiation agent, reacting the lithiation agent, and removing excess lithiation agent are directly adaptable to many lithium-ion battery cell preparation methods and systems, and can be performed similarly to the process of injecting the electrolyte. For example, an additional injection nozzle can be adapted to a lithium-ion battery cell assembly system for injection of the lithiation agent, prior to injection of the electrolyte.

In the preceding description, for the purposes of explanation, numerous details have been set forth in order to provide an understanding of various embodiments of the present technology. It will be apparent to one skilled in the art, however, that certain embodiments may be practiced without some of these details, or with additional details.

Having disclosed several embodiments, it will be recognized by those of skill in the art that various modifications, alternative constructions, and equivalents may be used without departing from the spirit of the embodiments. Additionally, a number of well-known processes and elements have not been described in order to avoid unnecessarily obscuring the present technology. Accordingly, the above description should not be taken as limiting the scope of the technology.

Where a range of values is provided, it is understood that each intervening value, to the smallest fraction of the unit of the lower limit, unless the context clearly dictates otherwise, between the upper and lower limits of that range is also specifically disclosed. Any narrower range between any stated values or unstated intervening values in a stated range and any other stated or intervening value in that stated range is encompassed. The upper and lower limits of those smaller ranges may independently be included or excluded in the range, and each range where either, neither, or both limits are included in the smaller ranges is also encompassed within the technology, subject to any specifically excluded limit in the stated range. Where the stated range includes one or both of the limits, ranges excluding either or both of those included limits are also included. Where multiple values are provided in a list, any range encompassing or based on any of those values is similarly specifically disclosed.

As used herein and in the appended claims, the singular forms “a”, “an”, and “the” include plural references unless the context clearly dictates otherwise. Thus, for example, reference to “a material” includes a plurality of such materials, and reference to “the cell” includes reference to one or more cells and equivalents thereof known to those skilled in the art, and so forth.

Also, the words “comprise(s)”, “comprising”, “contain(s)”, “containing”, “include(s)”, and “including”, when used in this specification and in the following claims, are intended to specify the presence of stated features, integers, components, or operations, but they do not preclude the presence or addition of one or more other features, integers, components, operations, acts, or groups.

What is claimed is:

1. An electrochemical cell comprising:
a cathode active material;
an electrolyte; and
an anode active material, wherein the electrolyte is between the anode active material and the cathode active material, wherein the anode active material includes an excess amount of lithium, and wherein the anode active material does not include metallic lithium.

2. The electrochemical cell of claim 1, wherein the excess amount of lithium corresponds to a quantity of lithium greater than an amount of delithiation of the cathode active material or greater than a lithium capacity of the cathode active material.

3. The electrochemical cell of claim 1, further comprising a solid-electrolyte interface on a surface of the anode active material, wherein the excess amount of lithium corresponds to a quantity of lithium greater than an amount of lithium in the solid-electrolyte interface and one or both of an amount of delithiation of the cathode active material or a lithium capacity of the cathode active material.

4. The electrochemical cell of claim 1, wherein the excess amount of lithium corresponds to a quantity of lithium in the anode available for use as lithium in the electrochemical cell is irreversibly lost during operation.

5. The electrochemical cell of claim 1, wherein the cathode active material comprises a fully delithiated cathode active material or a charged lithium-ion cathode active material.

6. The electrochemical cell of claim 1, wherein the cathode active material is a fully lithiated cathode active material or a discharged lithium-ion cathode active material.

7. The electrochemical cell of claim 1, wherein the cathode active material comprises a lithium-ion cathode active material selected from a lithium transition-metal oxide, a lithium transition-metal phosphate, or sulfur.

8. The electrochemical cell of claim 1, wherein the anode active material comprises one or more of graphite, silicon, or tin.

9. The electrochemical cell of claim 1, wherein the electrolyte is a polymer electrolyte, a liquid electrolyte, or a solid electrolyte.

10. The electrochemical cell of claim 1, further comprising one or more of a separator, a cathode current collector, an anode current collector, a case.

11. A method comprising:
obtaining a structure comprising:
a cathode active material; and
an anode active material, wherein the anode active material does not include metallic lithium, and wherein a space between the anode active material and the cathode active material does not contain an electrolyte;
injecting a lithiation redox agent into the space between the anode active material and the cathode active material;
reacting the lithiation redox agent with the anode active material to introduce an excess amount of lithium into the anode active material; and
injecting an electrolyte into the space between the anode active material and the cathode active material.

12. The method of claim 11, wherein the lithiation redox agent comprises one or more organolithium compounds.

13. The method of claim 11, wherein the lithiation redox agent comprises lithium, an organic solvent, and one or more of naphthalene, a naphthalene derivative, biphenyl, or a biphenyl derivative.

14. The method of claim 11, wherein the lithiation redox agent comprises an organic solvent selected from tetrahydrofuran (THF), dimethoxyethane (DME), ethylene carbonate (EC), diethyl carbonate (DEC), dimethyl carbonate (DMC), ethyl methyl carbonate (EMC), propylene carbonate (PC), ethyl proprionate (EP), or combinations of these.

15. The method of claim 11, wherein reacting the lithiation redox agent with the anode active material comprises applying a potential to the anode active material or a chemical reaction without applying potential.

16. The method of claim 11, further comprising removing unreacted lithiation redox agent or reaction products derived from the lithiation redox agent from the space between the anode active material and the cathode active material.

17. The method of claim 11, wherein the excess amount of lithium corresponds to a quantity of lithium greater than an amount of delithiation of the cathode active material or a lithium capacity of the cathode active material.

18. The method of claim 11, wherein reacting the lithiation redox agent with the anode active material comprises forming a solid-electrolyte interface on a surface of the anode active material.

19. The method of claim 18, wherein the excess amount of lithium corresponds to a quantity of lithium greater than an amount of lithium in the solid-electrolyte interface and one or both of an amount of delithiation of the cathode active material or a lithium capacity of the cathode active material.

20. The method of claim 11, wherein the structure comprises a jelly roll for a lithium-ion battery prior to injecting an electrolyte into the jelly roll.

21. A pre-lithiated anode active material or electrochemical cell comprising a pre-lithiated anode active material, prepared according to the method of any of claims 11-20.
